(19) United States
(12) Patent Application Publication
(10) Pub. No.: US 2006/0271366 A1
(43) Pub. Date: Nov. 30, 2006

(54) Synthesized speech based testing

(76) Inventor: Ronald S. Bruckman, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/141,511

(22) Filed: May 31, 2005

(51) Int. Cl. G10L 13/00

(52) U.S. Cl. 704/258

(57) ABSTRACT

In one exemplary method of testing an audio-based interface system, a prompt message to an operator is generated by speech synthesis. A response message from the operator is received in machine-intelligible form. The functioning of at least one component of the system is assessed from the messages.

### BACKGROUND

It is sometimes desirable for a human being and a computer or other machine to communicate over a telephone circuit. Telephones are very widely available, and are familiar, non-threatening devices to a great number of people. They thus enable the general public to communicate with central computers from almost anywhere. However, if additional hardware is required at the human end, or special training is required for the human user, much of the convenience is lost. Without such hardware or training, communication is effectively limited to speech in either direction, and the pulses or tones generated by the ordinary dial or keypad of the telephone for messages from the human to the computer. Therefore use is made of speech synthesis for communication from the computer to the human being. For communication from human beings to machines, use is made of either automatic speech recognition or the pulses or tones generated by an ordinary telephone for dialing.

Procedures for testing such communication systems have commonly been directed primarily to testing the application user interface, and have involved complicated sequences of operations to ensure that every message allowed for by the application is correctly generated or recognized by the computer.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of an embodiment of an audio-based interface system and an associated test system.

FIG. 2 is a flowchart of a first embodiment of a method of testing an audio-based interface system.

FIG. 3 is a flowchart of a second embodiment of a method of testing an audio-based interface system.

### DETAILED DESCRIPTION

Reference will now be made in detail to various embodiments of the present invention, example of which is illustrated in the accompanying drawings.

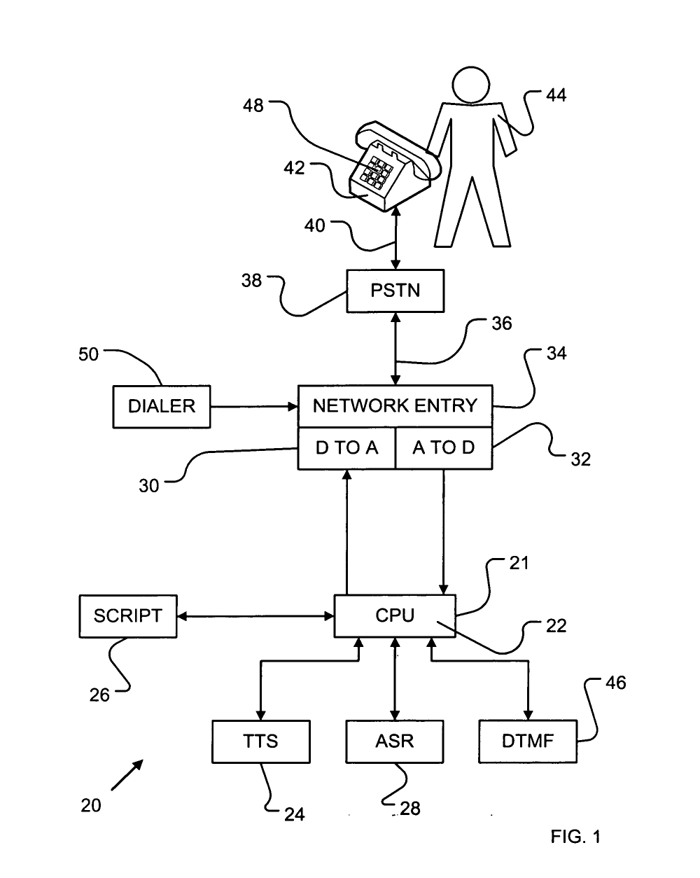

Referring to the drawings, and initially to FIG. 1, one form of interface system indicated generally by the reference numeral 20 is associated with a computer 21 having a processor 22. The processor 22 controls a text-to-speech (TTS) or speech synthesis unit 24, to which the processor provides text from a script file 26 in memory of the computer 21. The processor 22 also controls, and receives input from, an automatic speech recognition (ASR) unit 28. The TTS unit 24 supplies synthesized speech in digital form to a digital-to-analog (DA) converter 30, and the ASR unit 28 receives speech in digital form from an analog-to-digital (AD) converter 32. The converters 30 and 32 may form part of a modem at a port 34 where a telephone line 36 enters a service provider's digital network.

The telephone line 36 is connected to a telephone network 38. Another line 40 in the same network 38 is connected to a telephone 42. In the configuration shown in FIG. 1, the telephone 42 is being used by an operator 44 who is testing the interface system 20. The interface system 20 also includes a reader 46 for interpreting the Dual Tone Multi-frequency (DTMF) tones that are generated by the telephone 42 when the operator 44 presses the numbered buttons on the telephone keypad 48. The port 34 may also be provided with a dialer 50 controlled by the processor 22. The dialer 50 enables the computer 21 to place a telephone call through the telephone network 38 to the operator 44.

Alternatives to the arrangement of the blocks shown in FIG. 1 are possible. For example, to the extent that the TTS unit 24 and/or the ASR unit 28 is implemented in software, that unit may be a program running on the processor 22. The conversion between digital signals used by the processing devices and analog telephone signals may take place at various convenient stages. If the telephone 42 is connected to a digital network instead of the analog telephone network 38 shown in FIG. 1, then the AD and DA converters 30 and 32 may be part of the telephone 42, or may not be present as distinct components if the telephone has a fully digital microphone and earphone. To the extent that the TTS unit 24 and/or the ASR unit 28, and/or the DTMF reader 46 is implemented in hardware, that unit may be integrated with the DA or AD converter.

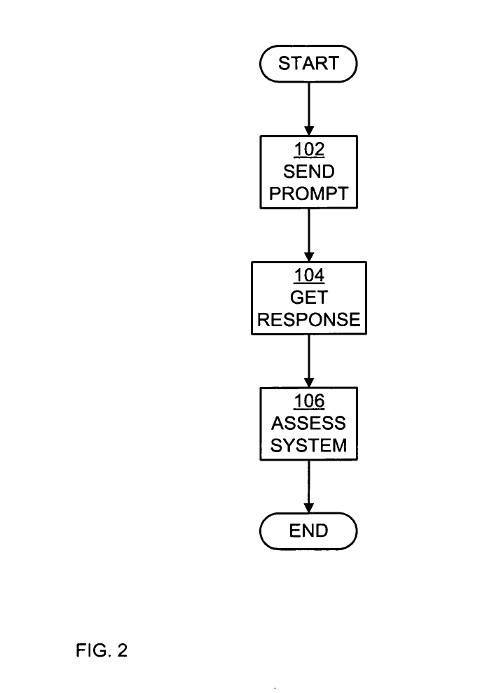

Referring now to FIG. 2, in an embodiment of a method of testing an audio-based interface system 20, in step 102 a test process causes the TTS unit 24 to generate a prompt message to the operator 44 by speech synthesis from text in the script 26. In step 104, the interface system 20 receives a response message from the operator 44. The response message may be speech that is rendered machine intelligible by the ASR unit 28, or DTMF tones that are understood, and converted to a more easily processed form, by the DTMF tone reader 46. In step 106, the test process running on the processor 22 assesses the functioning of at least one component of the interface system 20 from the messages sent and received.

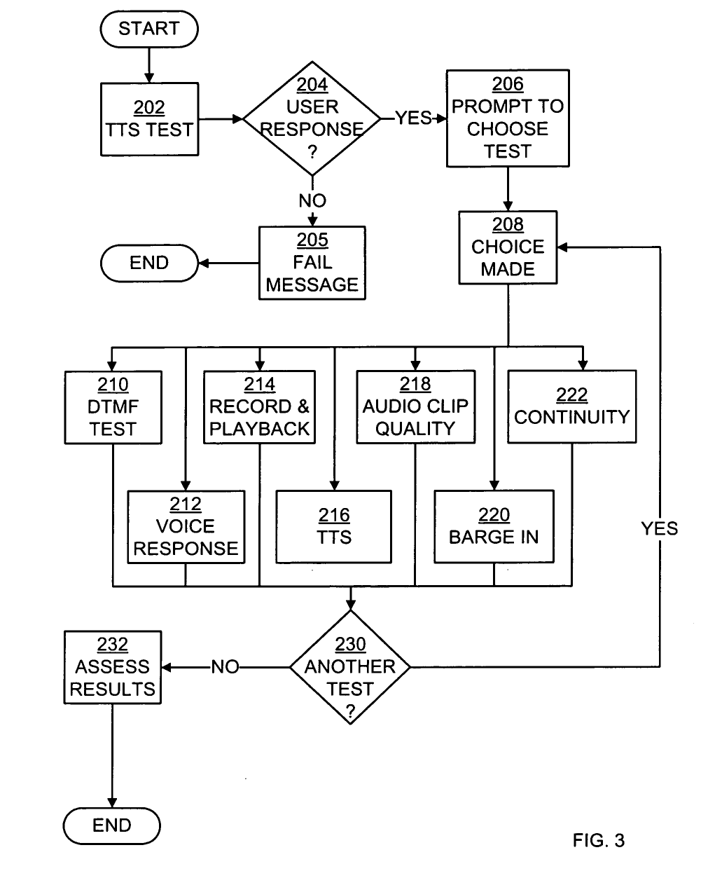

Referring now to FIG. 3, another embodiment of a method of testing an audio-based interface system 20 starts in step 202 with an interface system 20 under test configured, and an operator 44 connected by telephone 42 via 36, 38, and 40 to the interface system 20 under test. The interface system 20 may consist of components, including hardware and software, from different sources. In one exemplary implementation of the embodiment shown in FIG. 3, the interface system 20 may be tested to ensure that a change in one component of the interface system 20, or of a computer 21 on which the interface system 20 is running, has not unexpectedly interfered with the operation of other components of the interface system 20.

In step 202, the process starts with a simple test of a TTS subsystem, which may comprise the TTS unit 24 and the D to A converter 30. The TTS subsystem is provided with a script 26 requesting the operator 44 to respond, for example, by pressing a key on the telephone keypad 48 within a first time limit. The script 26 may inform the operator 44 that, if the operator 44 hears a further message within a second time limit, that will show the TTS subsystem and a DTMF subsystem, which may comprise the DTMF unit 46 and the A to D converter 32, are at least minimally functioning. In step 204, it is determined whether a response from the operator 44 is received within the time limit. If no response is received, the process deduces that either the TTS subsystem or the DTMF subsystem is inoperative. In step 205, the process waits for the second time limit to expire, and then sends out a TTS message announcing the failure and ends. The operator 44 may be able to deduce whether the failure is in the TTS subsystem or in the DTMF subsystem. For example, if the operator 44 receives the prompt message in step 202, the operator 44 responds, and then the operator 44 receives the failure-message in step 205, the operator 44 may deduce that the TTS subsystem is operative, and therefore that the failure is more likely to be in the DTMF subsystem. The defect may be remedied, and the process restarted.

If a valid response is detected by the DTMF subsystem in step 204, then in step 206 the process causes the TTS subsystem, starting within the second time limit, to read out a menu of available tests, specifying the response from the operator 44 to select each test. In step 208, the process confirms that a valid response was received from the operator 44, and identifies the test chosen. Steps 206 and 208 may be used as a further test of the DTMF subsystem, if the menu in step 206 and the first message from the test subsystem selected in step 208 are suitably worded. For example, one of the menu options may be “Press 1 for a full test of the DTMF subsystem,” and the operator 44 may press 1. If the interface system 20 then replies “You pressed 2, and selected a test of the Voice Recognition subsystem,” the operator 44 may easily infer that the DTMF subsystem is receiving tones from the telephone keypad 48, but is not recognizing the tones correctly or not processing the numbers recognized correctly. A similar test may be included in step 204, by asking the operator 44 in step 202 to press a specific key. However, testing in step 206 allows different DTMF tones to be tested on different occasions. The longer the menu, up to a number of items equal to the number of keys usable for making selections, e.g. up to 10 items in an embodiment, the more of the keys are tested.

Depending on the choice received in step 208, the process then branches to the appropriate test. For example, in step 210 the process may carry out a detailed test of the DTMF subsystem. The DTMF test may comprise prompting the operator 44 to press specified keys, and checking whether the DTMF subsystem reports the specified keys as pressed. In the DTMF test, and in all the tests shown in FIG. 3, the prompts and messages to the operator 44 are generated by the TTS subsystem from the script 26, enabling the operator 44 to monitor and assess at length the operation of the TTS subsystem. The process may assess the functioning of the DTMF subsystem automatically from the proportion of wrongly-recognized keys, or may report the errors individually to the operator 44, for example, by a message such as “I asked you to press [keynumber n]. I detected [keynumber m],” or both.

In step 212, the process may test a voice response subsystem, which may comprise the ASR unit 28 and the A to D converter 32. If the voice response subsystem is an Automatic Speech Recognition (ASR) subsystem, the testing process may be similar to the DTMF test of step 210. However, an ASR test may handle a significant proportion of events where the ASR subsystem reports a response received from the operator 44, but is not able to match that response to a specific valid response. The script 26 may therefore include messages such as “I was not able to recognize your response. Please repeat it,” or “I expected either 1, 2, 3, or 4. I heard either 7 or 11. Please repeat your response.”

If the test process is testing an interface system 20 that includes an ASR unit 28, the ASR grammar may be part of the interface system 20, and not provided by the test process. Different ASR units 28 may use different grammars. The scripts 26 may then be adapted to specify user responses that the particular ASR unit 28 can parse reliably. Other parts of the interface system 20 may then be tested without the tests being confused by the failure of one ASR grammar to parse a message that another grammar parses correctly. Alternatively, if a new ASR grammar is under test, the scripts 26 may specify user responses that are deliberately difficult to parse.

If the voice response subsystem requires the operator to speak immediately after the desired option is read out, then different scripts 26 may be used.

In step 214, the operator 44 may be invited to test a record and playback subsystem by speaking, listening to the playback, and assessing the quality of the playback. A script 26 may invite the operator 44 to enter the assessment using the keypad 48. The operator 44 may be permitted to choose what is spoken, or words may be specified in the script 26 to test specific aspects of the system quality. By repeated tests and suitably scripted questions, considerable detail may be gathered about the perceived quality of the sound recorded and played back.

In step 216, the TTS subsystem itself may be tested in more detail, by reading out TTS scripts 26 that request the operator 44 to key in an assessment of the TTS output similarly to the assessment described in step 214. The scripts may be deliberately phrased to test the vocabulary and/or clarity of speech of the TTS subsystem.

In step 218, the sound reproducing capabilities of the interface system 20 may be tested by playing sound clips provided, which may include speech and/or music, and asking the operator 44 to assess various aspects of the sound quality, similarly to the assessment described in step 214.

In step 220, the ability of the interface system 20 to handle “barge in,” that is to say, a response given by the operator 44 before the prompt has finished playing, may be tested. This is a test of the ability of the interface system 20 to discriminate outgoing prompt message from incoming response message when the two messages overlap. The “barge in” test also tests the ability of the interface system 20 to discriminate a user utterance from noise, or a valid utterance from an invalid utterance. The test may assume that the TTS subsystem and the DTMF or ASR subsystem are individually working properly. In this test, a TTS prompt from the testing process may be followed by, for example, a prompt from the application user interface or a further TTS message. The initial TTS message may instruct the operator 44 to make a response during the second message. The initial TTS message may also tell the operator 44 what response to make, or what possible responses to choose from.

In step 222, the testing process may be used to assist in the testing of other elements involved in the interaction between the operator 44 and the interface system 20, such as the continuity of the connection to the operator's telephone 42. In this test, the TTS script 26 may require only two short phrases, one to acknowledge that the interface system 20 has received a message from the operator 44, and the other to signal to the operator 44 that the telephone connection is open but that the interface system 20 has not recently heard anything from the operator 44. Alternatively, the interface system 20 may assess the quality of messages from the operator 44, and may select from a plurality of TTS scripts 26.

Other tests may be provided instead of, or in addition to, the tests described with reference to steps 210, 212, 214, 216, 218, 220, 222. For example, some tests may be omitted where the interface system 20 does not support the functionality that is tested by a specific test, or where that functionality will not be used in a specific application. Voice recognition and/or test-to-speech systems may test more than one language.

When a test is completed, the process proceeds to step 230, where it is decided whether to carry out another test. In FIG. 3, if the operator 44 chooses to run another test, the process then returns to step 208 to select the next test. In FIG. 3, the operator 44 chooses in step 206 which test to carry out first, and the tests are then carried out in a set order, until the process reaches the end of the order or is otherwise terminated at step 230. If it is decided not to run another test, either by the operator 44 or because all applicable tests have been completed, the process proceeds to step 232. If it is determined that further testing would be inappropriate, for example, because step 210 revealed a problem with the DTMF subsystem on which further tests would rely, the process may also proceed to step 232. In step 232, the results are assessed, either by a person or by automatic analysis of inputs from the operator 44 and data recorded by the testing process, or both. Quality and/or diagnostic reports may be generated at this stage.

By using TTS as the primary medium of communication from the testing process to the operator 44, the embodiments shown in the drawings enable thorough remote testing without the operator 44 using special equipment or having special training. The TTS scripts 26 can be made as detailed as is appropriate to provide the operator 44 with information and instructions to carry out the testing. Where the scripts, and appropriate parts of the testing program, are written in a computer programming language such as voice extension markup language (VXML) that is interpreted at run-time, rather than in compiled object code, changes to the testing process are easily and quickly made. Retraining of the operator 44 may be avoided, by updating the TTS scripts 26 to provide the operator with current information and instructions.

Various modifications and variations can be made in the present invention without departing from the spirit or scope of the invention.

For example, in the embodiments shown in FIGS. 2 and 3, the TTS scripts 26 are entirely concerned with testing the interface system 20. Alternatively, where an application user interface is part of the interface system 20 under test, some of the messages may relate to the application. The operator 44 may then hear, for example, a TTS script 26 in the testing process that requests a response, but the operator 44's response may then be passed to the application user interface. An example of such a TTS script 26 might read “Please press a number. If you press 1, you should hear a message that begins ‘Welcome to our automated banking system.’ . . .” A key not assigned in the main menu of the application user interface may be used to escape back to the testing process.

In the interests of clarity, FIG. 3 shows a single step 230 of determining whether to conduct another test, with the next test being predetermined. Alternatively, the process may return to step 206 and prompt the operator 44 to choose which test to run next. If the process requires a certain test to be followed by a specific other test, or to reduce the time spent on choosing tests, the process may return directly to step 208 after some tests and return to step 206 after other tests. If the operator 44 chooses to run another test, the process may return to step 206 and prompt the operator 44 to choose which test to run next. Where the process returns to step 206, and to the extent that the determination whether to run another test is a choice by the operator 44, that determination may be an additional choice in the menu at step 206.

The menu at step 206 may list all available tests, in which case the menu may be in the form of a single TTS script 26. Alternatively, the menu may be varied, for example, to omit inapplicable tests or tests that have already been completed, or to force certain tests to be conducted before other tests, in which case the spoken menu may be generated from a menu of distinct TTS scripts 26. For example, in FIG. 3, communication between the testing process and the operator 44 primarily uses the TTS and DMTF subsystems. The process may therefore be configured to force a full DTMF test, step 210, and/or a full TTS test, step 216, before carrying out other tests that rely on the TTS and DTMF subsystems.

In FIG. 3, a minimal TTS test and DTMF test are conducted in steps 202 and 204 every time the testing process is carried out. The full TTS and DTMF or ASR tests of steps 210, 212, 216 are carried out only when chosen, by the operator 44 or by the testing process, at steps 206, 208. Alternatively, steps 202 and 204 may be omitted (except to the extent that they are implicit in step 206), or the full tests of steps 210, 212, and/or 216 may be carried out every time the process is run. The choice may depend, for example, on the circumstances in which the test is being used.

Although in the interests of clarity the tests in steps 210 through 222 are shown as separate and distinct, most tests will in practice rely on functionality other than that under test, and will at least implicitly test that other functionality. The process may therefore be configured to detect and report errors and failures in components relied on but not explicitly under test. For example, almost any test will be affected by a basic failure in the TTS and DTMF subsystems.

Thus, it is intended that the present invention cover the modifications and variations of this invention provided they come within the scope of the appended claims and their equivalents.

What is claimed is:

1. A method of testing an audio-based interface system, comprising:
generating a prompt message to an operator by speech synthesis;
receiving in machine-intelligible form a response message from the operator; and
assessing the functioning of at least one component of said system from said messages.

2. A method according to claim 1, comprising assessing speech synthesis by a process comprising inferring whether or not the operator heard synthesized speech.

3. A method according to claim 1, comprising assessing speech synthesis by a process comprising inferring whether or not the operator correctly understood synthesized speech.

4. A method according to claim 1, comprising assessing reception of a response message by a process comprising detecting whether or not said response message is received after a prompt message that invites said response message.

5. A method according to claim 1, comprising assessing reception of a response message by a process comprising determining whether or not a response message received after a prompt message is a valid response to said prompt message.

6. A method of testing an audio-based interface system, comprising:
generating a prompt message to an operator from machine-readable text by speech synthesis;
receiving in machine-intelligible form a response message from the operator; and
generating a further message to said operator determined by said response message;
wherein said prompt message informs said operator what said further message should be for a specific response message if said interface system is functioning correctly.

7. A method according to claim 6, comprising assessing speech synthesis, wherein assessing speech synthesis comprises inferring whether or not the operator heard synthesized speech.

8. A method according to claim 6, comprising assessing speech synthesis, wherein assessing speech synthesis comprises inferring whether or not the operator correctly understood synthesized speech.

9. A method according to claim 6, comprising assessing reception of response messages, wherein assessing reception of response messages comprises detecting whether or not a response message is received after a prompt message that invites a response message.

10. A method according to claim 6, comprising assessing reception of response messages, wherein assessing reception of response messages comprises determining whether or not a response message received after a prompt message is a valid response to said prompt message.

11. An audio-based interface system, comprising:
a speech synthesizer for generating and transmitting prompt messages to an operator;
a receiver for receiving in machine-intelligible form response messages from the operator; and
an analyzer in communication with said speech synthesizer and said receiver and arranged to assess functioning of at least one component of said system from said messages.

12. A system according to claim 11, wherein said speech synthesizer is arranged to generate said prompt messages from text.

13. A system according to claim 11, wherein said analyzer is arranged to infer from a response received after at least one said prompt message whether or not the operator heard said prompt message to assess speech synthesis.

14. A system according to claim 11, wherein said analyzer is arranged to infer from a response received after at least one said prompt message whether or not the operator correctly understood said prompt message to assess speech synthesis.

15. A system according to claim 11, wherein said analyzer is arranged to detect whether or not a response message is received after a prompt message that invites a response message to assess reception of response messages.

16. A system according to claim 11, wherein said analyzer is arranged to determine whether or not a response message received after a prompt message is a valid response to said prompt message to assess reception of response messages.

17. A system according to claim 11, wherein at least one said prompt message informs said operator what a further prompt message should be for a specific response message if said interface system is functioning correctly.

18. An audio-based interface system, comprising:
speech synthesizing means for generating and transmitting prompt messages to an operator;
receiving means for receiving in machine-intelligible form response messages from the operator; and
analyzing means for communicating with said speech synthesizer and said analyzer and for assessing functioning of at least one component of said system from said messages.

19. A computer-readable medium comprising code representing instructions for testing an audio-based interface system, comprising:
machine-readable text;
instructions to generate a prompt message to an operator from the machine-readable text by speech synthesis; and
instructions to assess functioning of at least one component of said system from said prompt message and a response message received in machine-intelligible form.

20. A medium according to claim 19, wherein the text includes at least one said prompt message to inform said operator that if said operator enters a specific response message said operator should receive a specific further prompt message.

21. A medium according to claim 19, further comprising instructions for inferring whether or not the operator heard synthesized speech.

22. A medium according to claim 19, further comprising instructions for inferring whether or not the operator correctly understood synthesized speech.

23. A medium according to claim 19, further comprising instructions for detecting whether or not a response message is received after a prompt message that invites a response message.

24. A medium according to claim 19, further comprising instructions for determining whether or not a response message received after a prompt message is a valid response to said prompt message.
